(19) United States
(12) Patent Application Publication
(10) Pub. No.: US 2013/0297301 A1
(43) Pub. Date: Nov. 7, 2013

(54) COUPLING AN ELECTRONIC SKIN TATTOO TO A MOBILE COMMUNICATION DEVICE

(71) Applicant: William P. Alberth, JR., Prairie Grove, IL (US)

(72) Inventor: William P. Alberth, JR., Prairie Grove, IL (US)

(73) Assignee: MOTOROLA MOBILITY, INC., Libertyville, IL (US)

(21) Appl. No.: 13/462,881

(22) Filed: May 3, 2012

(51) Int. Cl. G10L 21/02

(52) U.S. Cl. 704/226; 704/E21.002

(57) ABSTRACT

A system and method provides auxiliary voice input to a mobile communication device (MCD). The system comprises an electronic skin tattoo capable of being applied to a throat region of a body. The electronic skin tattoo can include an embedded microphone; a transceiver for enabling wireless communication with the MCD; and a power supply configured to receive energizing signals from a personal area network associated with the MCD. A controller is communicatively coupled to the power supply. The controller can be configured to receive a signal from the MCD to initiate reception of an audio stream picked up from the throat region of the body for subsequent audio detection by the MCD under an improved signal-to-noise ratio than without the employment of the electronic skin tattoo.

### F THE DISCLOSURE

The present disclosure relates generally to acoustic noise for a mobile communication device and more particularly to reducing acoustic noise with an auxiliary voice input.

### BACKGROUND

Mobile communication devices are often operated in noisy environments. For example, large stadiums, busy streets, restaurants, and emergency situations can be extremely loud and include varying frequencies of acoustic noise. Communication can reasonably be improved and even enhanced with a method and system for reducing the acoustic noise in such environments and contexts.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example system in accordance with one or more embodiments.

FIG. 2 is a block diagram of an example electronic skin tattoo in accordance with some embodiments.

FIG. 3 is an example illustration of the adherence of the electronic skin tattoo to a throat region of a body.

FIG. 4 is an example flowchart for a method according to one or more embodiments.

FIG. 5 is an example flowchart for another method according to one or more embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system is described herein for providing auxiliary voice input to a mobile communication device, also sometimes referred to a mobile computing device as well and hereinafter termed, “MCD”. The system comprises an electronic skin tattoo capable of being applied to a throat region of a body. The electronic skin tattoo can include an embedded microphone; a transceiver for enabling wireless communication with the MCD; and a power supply configured to receive energizing signals from a personal area network associated with the MCD. A controller is communicatively coupled to the power supply. The controller can be configured to receive a signal from the MCD to initiate reception of an audio stream picked up from the throat region of the body for subsequent audio detection by the MCD under an improved signal-to-noise ratio than without the employment of the electronic skin tattoo.

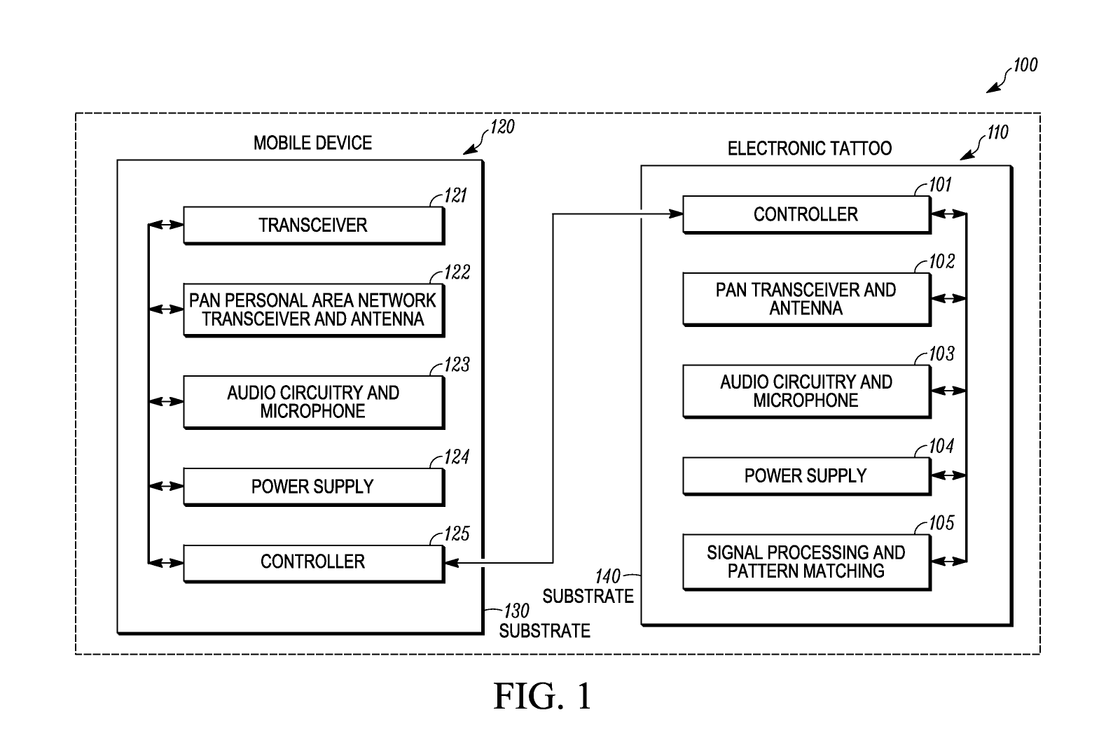

FIG. 1 is a block diagram of an example system 100 comprising an electronic tattoo 110 and a mobile communication device (MCD) 120 that are communicatively coupled. Electronic tattoo 110, which can be applied to a region of the body via an adhesive, is further comprised of a controller 101, a personal area network (PAN) transceiver 102, audio circuitry 103, a power supply 104, and a signal processor 105.

Controller 101 of electronic tattoo 110 can be configured to execute programs or instructions to enable communicative coupling of the electronic tattoo to external electronic devices such as a smartphone, a gaming device, a tablet computer, a wearable computer, for example. Controller 101 also controls signaling that occurs internal to the circuitry of the electronic tattoo 110. PAN transceiver 102 can be further comprised of a discrete transmitter and receiver (not shown). PAN transceiver 102 can comprise circuitry configured to receive near field communication signals (NFC), Bluetooth® signals, and Zigbee® signals or other contemplated close proximity communication protocols. These signals can be emanated from a personal area network associated with the MCD 120. Accordingly, the MCD 120 will also be equipped with close range communication technology such as NFC, Bluetooth®, and Zigbee®. As used herein, the term close proximity communication means wireless communication between at least two devices over a short distance, for example, less than 10 meters, less than 5 meters less than 2 meters, less than 10 centimeters, less than 5 centimeters, less than 2 centimeters, or less than 1 centimeter.

Regarding the NFC protocol as a close proximity communication protocol, the NFC protocol can be specified in accordance with radio frequency identification (RFID) standards including, but not limited to, ISO/IEC 1443, ISO/IEC 18092 (e.g., with Manchester coding at 212 kbit/s in the 13.56 MHz range), and FeliCa.

Other examples of close proximity protocols are wireless infrared (IR) communication protocols. Still other close proximity protocols can be used and the embodiments described herein are not limited in this regard.

The electronic tattoo 110 can comprise audio circuitry 103 that enables reception of acoustic signals from a person's throat when the electronic tattoo 110 is applied to a throat region of a body. Here it is contemplated that the electronic tattoo 110 can also be applied to an animal as well. Audio circuitry 103 can also include a microphone for emitting sound corresponding to fluctuations of muscle or tissue in the throat.

A power supply 104 for the electronic tattoo 110 can be configured to receive energizing signals from external sources, including a personal area network employing NFC, Bluetooth®, or Zigbee® technology. The power supply 104 can also simply be a battery that may or may not be rechargeable. Power supply 104 is also communicatively coupled to controller 101 of the electronic tattoo 110 for receiving initialization signals to begin a charging sequence, for example. The power supply 104 can also receive electrical energy from PAN transceiver 102 that can specifically comprise an NFC transceiver, a Bluetooth® transceiver, or a Zigbee® transceiver.

A signal processor 105 can be employed by electronic tattoo 110 for reducing signal-to-noise ratios of audible sound emanating from a throat and picked up by audio circuitry 103. The signal processor 105 can be configured to perform signal pattern matching of detected audible sounds. Additional circuitry can be employed by the electronic tattoo on a substrate 140, including analog-to-digital conversion circuitry and data compression technology. At least some of the described electronic components of electronic tattoo 110 can be considered as microelectronic technology or nano-technology.

System 100 also includes MCD 120. MCD 120 further comprises several electronic components that are communicatively coupled, such as a communications transceiver 121; a personal area network (PAN) transceiver 122; an audio circuitry 123; a power supply 124; and a controller 125. The aforementioned electronic components reside on a substrate 130 and can be controlled by electronic signaling along a bus, for example. Communications transceiver 121 is configured to transmit and receive communication signals and data over one or more various networks including USB, Ethernet, 2G, 3G, 4G, LTE, HSPA+, and wireless LAN.

PAN transceiver 122 can include an antenna and a transmitter for receiving and sending signals corresponding to Bluetooth®, Zigbee®, and NFC technologies. Audio circuitry 123 is configured to provide audio output and receive audio input via a microphone within MCD 120. The audio output can be speech or media content such as music. Likewise, the audio input can be external ambient sounds, speech, or media content.

A power supply 124 provides electrical power to the several electronic components of MCD120. The power supply can be a rechargeable battery, but need not be so. For example, the power supply may employ solar panel technology, capacitive technology, nanotechnology, or electro-mechanical technology, for example, as a means to generate and distribute electrical current.

A controller 125 can be configured or programmed to control various aspects of the communicatively coupled electronic components, including power distribution, communication signaling, signal processing, and operative selection, for example.

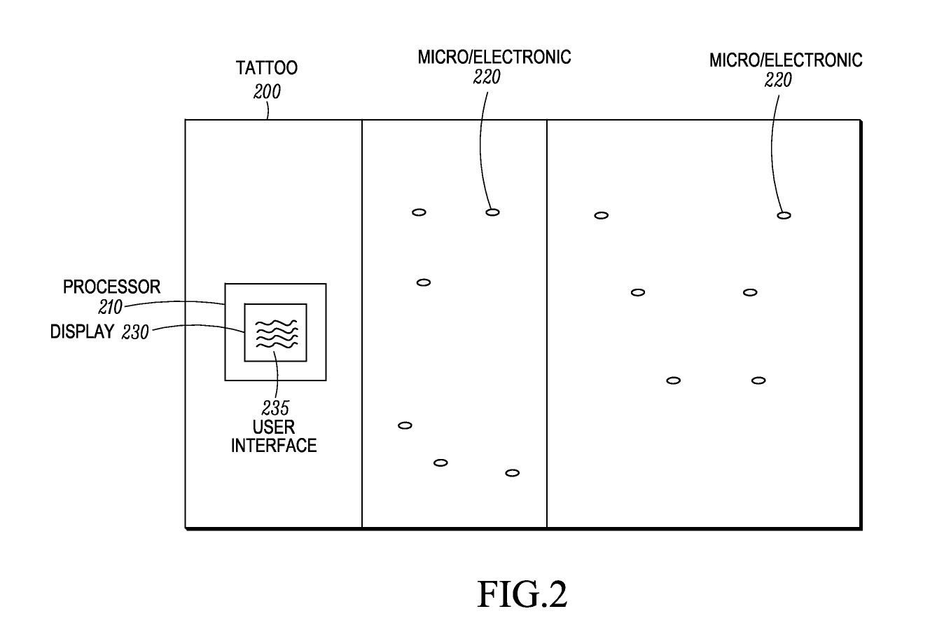

FIG. 2 illustrates, by way of example, an electronic skin tattoo 200 that can be applied to a region of a body. The electronic skin tattoo 200 can include a processor 210 and several microelectronics 220. In addition, the electronic skin tattoo 200 can further include a display 230 with a user interface 235.

Processor 210 of the electronic skin tattoo 200 can be configured or programmed to control operation of microelectronics 220. The microelectronics 220 can be passive electronic components, such as resistors and capacitors and can also include active electronic components, such as A/D convertors, a throat microphone, sensors, and signal filtering, for example. The microelectronics 220 can be employed upon a flexible substrate of the electronic skin tattoo 200.

An optional display 230 can be configured to operate upon the electronic skin tattoo 200. The display 230 may further include a user interface 235 for inputting commands to the electronic skin tattoo 200. It is contemplated that the user interface 235 or a sensor in the electronic skin tattoo 200 may allow for or signal to mute (and unmute) acoustic sounds emanating from the throat microphone of the electronic skin tattoo 200. Furthermore, the throat microphone of electronic skin tattoo 200 can have its own identification and be selectable in a group setting, for example, where multiple users are wearing an electronic skin tattoo 200.

It is also contemplated that the display 230 may be instructed by processor 210 to illuminate visually upon the electronic skin tattoo 200 meeting a criteria, recognizing a voice pattern, or surpassing a frequency threshold, for example. That is a certain word can be spoken that will enable the display 230 to illuminate when the electronic skin tattoo 200 senses the pattern or frequency corresponding to the spoken word or utterance. In the same vein, a motion of the throat muscle or tissue may also cause the display 230 to light.

Optionally, the electronic skin tattoo 200 can further include a galvanic skin response detector to detect skin resistance of a user. It is contemplated that a user that may be nervous or engaging in speaking falsehoods may exhibit different galvanic skin response than a more confident, truth telling individual.

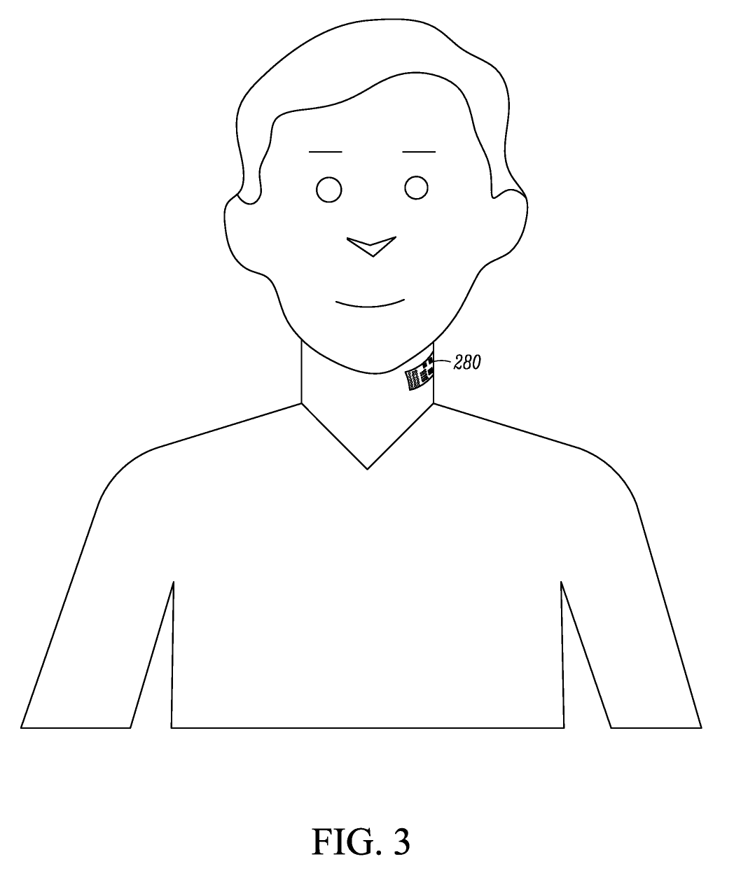

FIG. 3 illustrates one application of the electronic skin tattoo 200 of FIG. 2. The electronic skin tattoo 200 can be applied to the throat region of a body, but can also be embedded in a collar or band that would be worn around the throat a user. The collar or band may be flexible or stiff

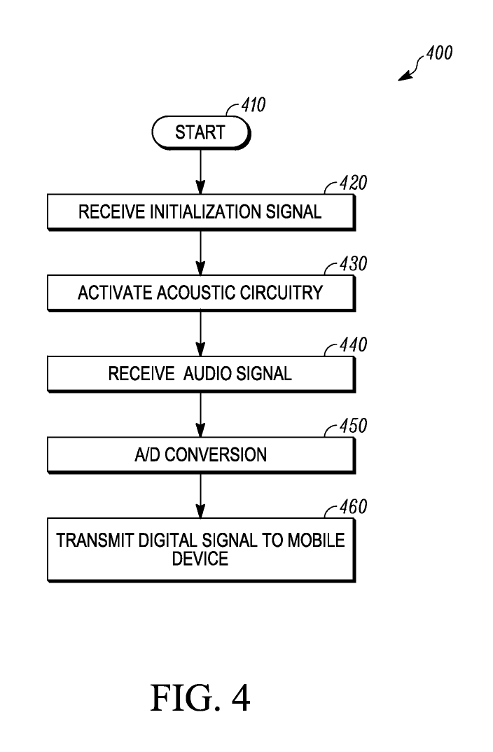

FIG. 4 illustrates an example flowchart 400 for a method or process that provides auxiliary voice input to a MCD 120. A controller of the electronic skin tattoo 200 begins the process at step 410. Step 420 receives an initialization signal at the electronic skin tattoo 200 that includes an embedded microphone and transceiver. The initialization signal can be sent from the MCD 120 or another source. The initialization signal can be manually input via user interface 235 of the electronic skin tattoo 200.

Step 430 activates acoustic circuitry for the electronic skin tattoo 200, thus enabling acoustic pick up of sounds emanating from a throat region of a body when the electronic skin tattoo 200 is applied proximate to the throat region. Step 440 actually receives the audio signal from the embedded microphone of the electronic skin tattoo 200. When the audio signal is in its raw, analog form, step 450 converts the analog audio signal to a digital signal via an A/D processor. Step 460 transmits the digital form of the audio signal to the MCD. Within the MCD, the digitized audio information may be combined with the audio information received from the microphone within the MCD (part of 123) to improve the audio quality. The improved audio quality may be used to improve accuracy of voice commands to the MCD, or may be used to improve intelligibility of the audio communication uplink from the MCD. One method of improving the audio quality is to use the audio signal from the electronic tattoo to determine if the audio includes either a voiced or unvoiced component and to determine the pitch of a voice, should one be detected. Other methods of combining audio from multiple sources are known in the art. Notably, an auxiliary voice input can be either an analog or digital representation of a MCD user's voice.

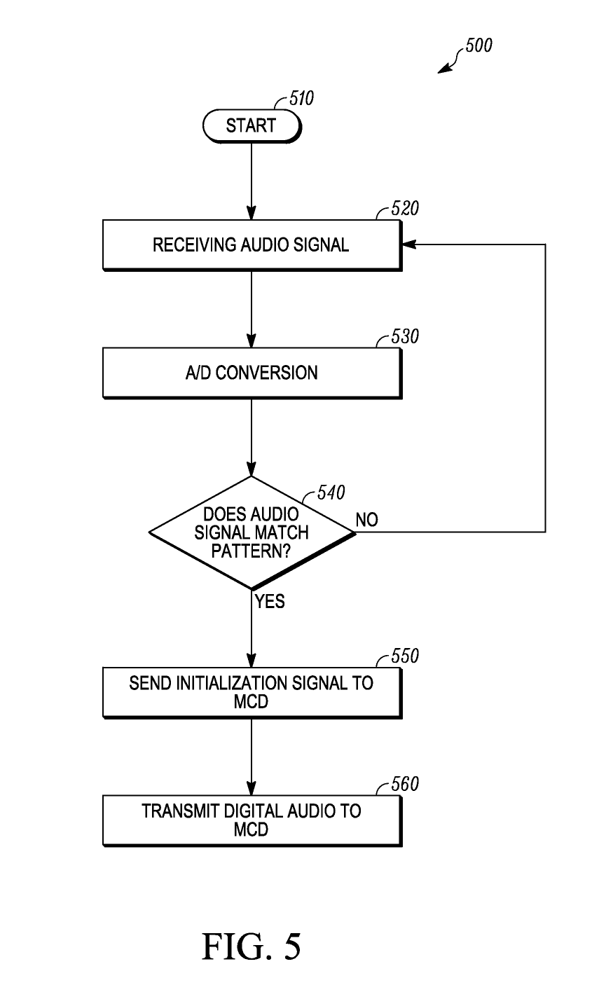

FIG. 5 illustrates another example flowchart 500 for providing auxiliary voice input to an MCD 120. A controller of the electronic skin tattoo 200 begins the process at step 510. Step 520 actually receives the audio signal from the embedded microphone of the electronic skin tattoo 200. When the audio signal is in its raw, analog form, step 530 converts the analog audio signal to a digital signal via an A/D processor.

Step 540 determines whether the received audio signal matches a predetermined voice pattern. The voice pattern can be in the form of frequency, phase, modulation, volume, or some other means of characterization for the audio signal. The predetermined pattern can be based on a user's vocal intonation, on a specific word or words, on a melody, or on a harmonic tone/vibration, for example. When the audio signal does match the predetermined pattern, Step 550 sends an initialization signal to MCD 120. Step 560 transmits the digital form of the audio signal to the MCD 120.

Step 560 may also send digitized representation of additional audio generated by the wearer and captured by the microphone of the electronic skin tattoo (200). It is also possible that the MCD 120 may discern more then one predetermined pattern, and the other patterns may result in different functions. For example, a second predetermined pattern, when recognized, may cause the electronic skin tattoo 110 to stop sending data. A third predetermined pattern may cause the transceiver of the electronic skin tattoo 110 to send data to a second MCD (not shown). A fourth predetermined pattern may cause the electronic skin tattoo 110 to send a message to the MCD 120, which causes the MCD 120 to perform or direct another action, such as sending a message to emergency 911 (or its equivalent) with location information. Alternatively, a preformatted message can also be sent to a predetermined destination.

Alternatively, in another embodiment, any predetermined pattern, when recognized, causes the auxiliary voice input to be transmitted as a second signal to the MCD 120, which causes the MCD 120 to perform a second function. Thereafter, the second function when performed by the MCD 120 sends a message to a third party. Alternatively, the second function can also terminate a communication session.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A system for providing auxiliary voice input to a mobile communication device (MCD), comprising:
an electronic skin tattoo capable of being applied to a throat region of a body; the electronic skin tattoo further comprising:
a microphone embedded in the electronic skin tattoo;
a transceiver that enables wireless communication with the mobile communication device;
a power supply configured to receive energizing signals from a personal area network associated with the MCD;
a controller communicatively coupled to the power supply; and
wherein the electronic skin tattoo is capable of receiving an initialization signal at the controller and from the MCD to initiate reception of an audio stream picked up from the throat region of the body for subsequent audio detection by the MCD under an improved signal-to-noise ratio than without employing the electronic skin tattoo.

2. The system according to claim 1, wherein the power supply further comprises a battery.

3. The system according to claim 2, wherein the initialization signal from the MCD cause the battery in the power supply to charge.

4. The system according to claim 1, further comprising a near field communication (NFC) transceiver embedded in the electronic skin tattoo for communicating with the personal area network.

5. The system according to claim 4, wherein the NFC transceiver provides electrical energy to the power supply on the electronic skin tattoo, when the MCD is within proximate range.

6. The system according to claim 1, wherein the MCD is activated either via application software or hardware switches.

7. The system according to claim 1, the electronic skin tattoo further comprising analog-to-digital conversion circuitry and data compression technology.

8. A system for providing auxiliary voice input to a mobile communication device (MCD), comprising:
an electronic skin tattoo capable of being applied to a throat region of a body; the electronic skin tattoo further comprising:
a microphone embedded in the electronic skin tattoo;
a transceiver that enables wireless communication with the mobile communication device;
a signal processor comprising circuitry for receiving vocal signals and comparing to a predetermined patterned; and
wherein the electronic skin tattoo is configured to provide an initialization signal as a a wake-up sequence to the MCD based on an audio stream, having the predetermined pattern, as picked up from the throat region of the body.

9. The system according to claim 8, further comprising a power supply having a battery.

10. The system according to claim 9, wherein the initialization signal from the MCD cause the battery in the power supply to charge.

11. The system according to claim 8, further comprising a near field communication (NFC) conductor embedded in the electronic skin tattoo.

12. The system according to claim 11, wherein the NFC conductor provides electrical energy to the power supply of the electronic skin tattoo.

13. A method for providing auxiliary voice input to a mobile communication device (MCD), comprising:
receiving an initialization signal at an electronic skin tattoo embedded with a microphone and transceiver;
activating acoustic circuitry for the electronic skin tattoo;
receiving an audio signal from the embedded microphone;
converting audio signal to digital signal; and
transmitting the digital signal to the MCD.

14. The method according to claim 13, further comprising providing electrical energy from a near field communication (NFC) conductor to a power supply of the electronic skin tattoo.

15. A method for providing an auxiliary voice input to a mobile communication device (MCD), comprising:
receiving an audio signal from an embedded microphone within an electronic skin tattoo placed on a throat region of a body;
converting the audio signal to a digital signal;
determining whether the audio signal matches a first predetermined pattern; and
sending an initialization signal to the MCD when the audio signal matches the first predetermined pattern; and
transmitting the digital signal to the MCD.

16. The method according to claim 15, further comprising providing electrical energy from a near field communication (NFC) conductor to a power supply of the electronic skin tattoo.

17. The method according to claim 15, wherein a second predetermined pattern, when recognized, causes the auxiliary voice input to be transmitted as a second signal to the MCD, which causes the MCD to perform a second function.

18. The method of claim 17, wherein the second function, performed by the MCD, sends a message to a third party.

19. The method of claim 17, wherein the second function, performed by the MCD, terminates a communication session.
